(19) United States
(12) Patent Application Publication
(10) Pub. No.: US 2011/0135437 A1
(43) Pub. Date: Jun. 9, 2011

(54) HORIZONTAL MULTI-JOINT ROBOT AND TRANSPORTATION APPARATUS INCLUDING THE SAME

(75) Inventors: Koji TAKESHITA, Fukuoka (JP); Yoshiki Kimura, Fukuoka (JP)

(73) Assignee: KABUSHIKI KAISHA YASKAWA DENKI, Kitakyushu-shi (JP)

(21) Appl. No.: 12/944,726

(22) Filed: Nov. 12, 2010

(30) Foreign Application Priority Data
Dec. 7, 2009 (JP) 2009-277163

(51) Int. Cl. B25J 11/00; B25J 18/00

(52) U.S. Cl. 414/744.5; 901/27; 901/14

(57) ABSTRACT

A third arm is provided in addition to an end effecter, a first arm and a second arm. The third arm performs swinging and turning motion until a third rotational axis is aligned with an extension of an axial line on an access position. Then, the end effecter moves linearly to transport a workpiece from and to the access position.

### CROSS-REFERENCE TO RELATED APPLICATIONS

The present application claims priority under 35 U.S.C. §119 to Japanese Patent Application No. 2009-277163, filed Dec. 7, 2009. The contents of this application are incorporated herein by reference in their entirety.

### BACKGROUND OF THE INVENTION

1. Field of the Invention

The present invention relates to a configuration of a horizontal multi-joint robot.

2. Discussion of the Background

In semiconductor manufacturing equipment and the like, conventionally, a horizontal multi-joint robot has been used for transporting a workpiece such as a liquid crystal glass, a reticle or a semiconductor wafer from a cassette to a process device, and vice versa. JP 07-237156 A discloses an example of such a horizontal multi-joint robot.

For example, in a case where a plurality of cassettes, process devices, and the like are arranged linearly, there has also been used a horizontal multi-joint robot that includes a direct-acting mechanism for causing the horizontal multi-joint robot to move in parallel with the arrangement.

### SUMMARY OF THE INVENTION

According to one aspect of the present invention, there is provided a horizontal multi-joint robot for transporting a workpiece to a desired transportation position. The horizontal multi-joint robot includes an end effecter, a horizontal multi-joint type arm section, a base and an interlocking mechanism. The end effecter holds a workpiece. The horizontal multi-joint type arm section includes a first arm, a second arm and a third arm. The first arm has a first rotational axis at a first end thereof, and supports the end effecter such that the end effecter turns about the first rotational axis. The second arm has a second rotational axis at a first end thereof, and supports a second end of the first arm such that the first arm turns about the second rotational axis. The third arm has a third rotational axis at a first end thereof, and supports a second end of the second arm such that the second arm turns about the third rotational axis. The base has a fourth rotational axis, and supports a second end of the third arm such that the third arm turns about the fourth rotational axis. The interlocking mechanism causes the end effecter to turnabout the first rotational axis with an angular velocity, which is one-half as small as an angular velocity of the first arm that turns about the second rotational axis in a first direction, in a second direction which is opposite to the first direction in a case where a distance from the first rotational axis to the second rotational axis is equal to a distance from the second rotational axis to the third rotational axis. Herein, the workpiece is transported in such a manner that the third arm performs swinging and turning motion until the third rotational axis is aligned with an imaginary extension of an axial line on the transportation position.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a plan view illustrating a horizontal multi-joint robot according to a first embodiment of the present invention;

FIG. 2 is a simplified longitudinal section view illustrating a power transmission mechanism of the horizontal multi-joint robot illustrated in FIG. 1;

FIG. 3 is a plan view illustrating a situation that the horizontal multi-joint robot illustrated in FIG. 1 picks up a workpiece at a transportation position;

FIG. 4 is a simplified longitudinal section view illustrating a base in order to describe a lifting mechanism of the horizontal multi-joint robot illustrated in FIG. 1;

FIG. 5 is a plan view illustrating a horizontal multi-joint robot according to a second embodiment of the present invention;

FIGS. 6A and 6B are plan views each illustrating a situation that a third arm of the horizontal multi-joint robot illustrated in FIG. 1 performs swinging and turning motion; and

FIG. 7 is a plan view illustrating a situation that the third arm performs swinging and turning motion which is different from that illustrated in FIGS. 6A and 6B.

### DESCRIPTION OF THE EMBODIMENTS

Embodiments will now be described with reference to the accompanying drawings, wherein like reference numerals designate corresponding or identical elements throughout the various drawings.

### First Embodiment

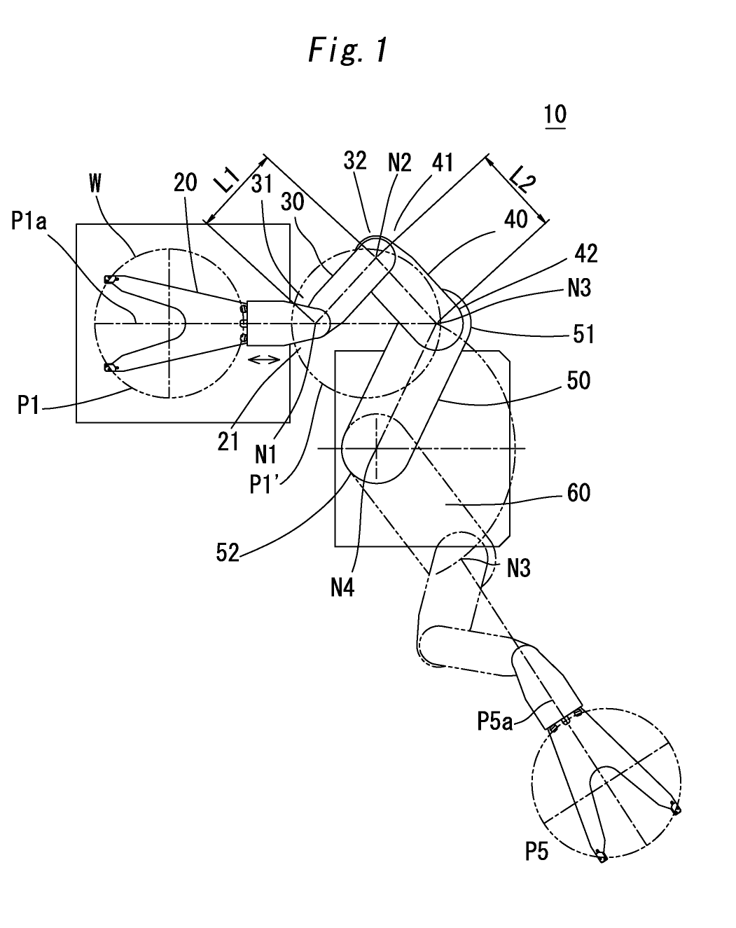

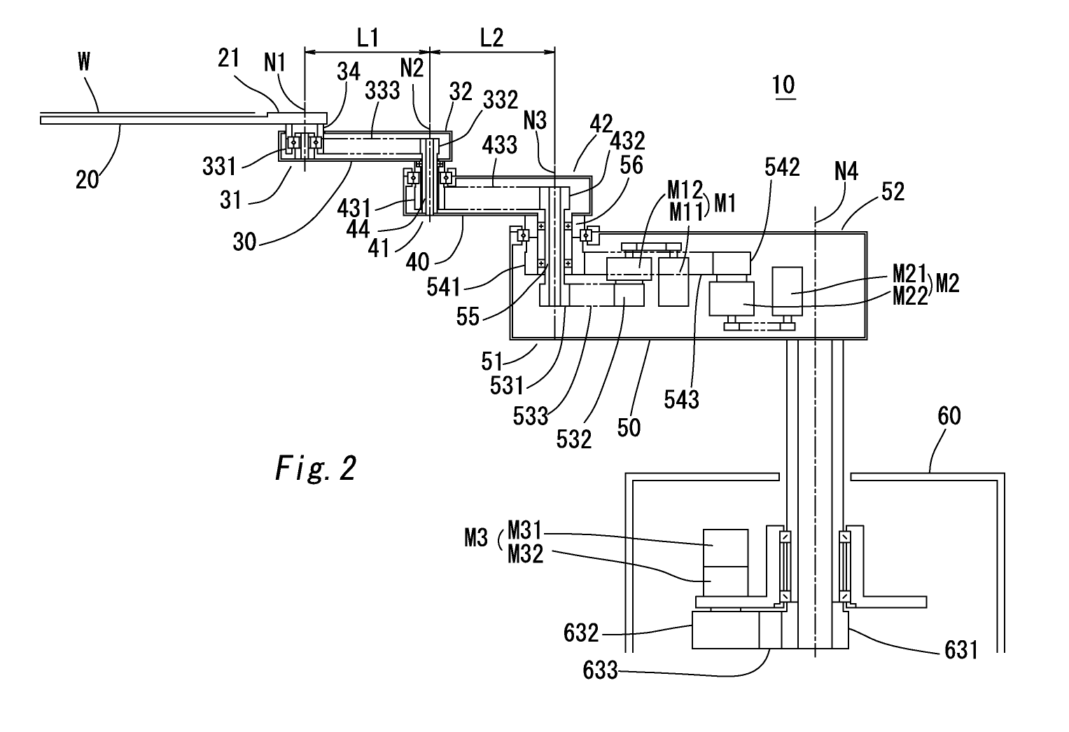

FIG. 1 is a plan view illustrating a horizontal multi-joint robot according to a first embodiment of the present invention. FIG. 2 is a simplified longitudinal section view illustrating a power transmission mechanism of the horizontal multi-joint robot illustrated in FIG. 1.

As illustrated in FIG. 1, the horizontal multi-joint robot 10 includes an end effecter 20, a first arm 30, a second arm 40, a third arm 50 and a base 60. The end effecter 20 holds a workpiece W. The first arm 30 has a first rotational axis N1 at a first end 31 thereof, and supports a root 21 of the end effecter 20 such that the end effecter 20 can turn about the first rotational axis N1. The second arm 40 has a second rotational axis N2 at a first end 41 thereof, and supports a second end 32 of the first arm 30 such that the first arm 30 can turn about the second rotational axis N2. The third arm 50 has a third rotational axis N3 at a first end 51 thereof, and supports a second end 42 of the second arm 40 such that the second arm 40 can turn about the third rotational axis N3. The base 60 has a fourth rotational axis N4, and supports a second end 52 of the third arm 50 such that the third arm 50 can turn about the fourth rotational axis N4.

As illustrated in FIG. 2, moreover, the horizontal multi-joint robot 10 also includes a first driving mechanism M1, a second driving mechanism M2 and a third driving mechanism M3. The first driving mechanism M1 causes the first arm 30 to turn about the second rotational axis N2 with respect to the second arm 40. The second driving mechanism M2 causes the second arm 40 to turn about the third rotational axis N3 with respect to the third arm 50. The third driving mechanism M3 causes the third arm 50 to turn about the fourth rotational axis N4 with respect to the base 60.

Further, the respective elements are arranged such that a distance L1 from the first rotational axis N1 to the second rotational axis N2 is equal to a distance L2 from the second rotational axis N2 to the third rotational axis N3.

The first driving mechanism M1 includes a motor M11 and a decelerator M12. The second driving mechanism M2 includes a motor M21 and a decelerator M22. The first driving mechanism M1 and the second driving mechanism M2 are placed in the third arm 50. The third driving mechanism M3 includes a motor M31 and a decelerator M32, and is placed in the base 60. The first driving mechanism M1 causes the first arm 30 to turn about the second rotational axis N2. The second driving mechanism M2 causes the second arm 40 to turn about the third rotational axis N3. The third driving mechanism M3 causes the third arm 50 to turn about the fourth rotational axis N4. Occasionally, each of the driving mechanisms M1 to M3 includes no decelerator.

The first driving mechanism M1 and the second driving mechanism M2 each including the heavy motor and the heavy decelerator are placed in the third arm 50, and the third driving mechanism M3 also including the heavy motor and the heavy decelerator is placed in the base 60. As a result, the arm section can be reduced in weight at the distal end thereof. Thus, the entire arm section can be realized in low inertia. Hence, this embodiment adopts the configuration described above.

The horizontal multi-joint robot according to this embodiment is configured as follows with regard to operations of the end effecter 20, first arm 30 and second arm 40. That is, the end effecter 20 moves linearly along a straight line connecting between the first rotational axis N1 and the third rotational axis N3 while being oriented in a given direction. The following description is given about the configuration for realizing the operations.

As illustrated in FIG. 2, a second rotational input shaft 56 and a first rotational input shaft 55 are provided around the third rotational axis N3. The second rotational input shaft 56 has a hollow shape, and receives a mechanical power from the second driving mechanism M2. The first rotational input shaft 55 is placed in the second rotational input shaft 56 so as to be concentric with the second rotational input shaft 56, and receives a mechanical power from the first driving mechanism M1. The second arm 40 is secured to an end of the second rotational input shaft 56. A driving pulley 432 is provided at an end of the first rotational input shaft 55. The first rotational input shaft 55 is placed in the second end 42 of the second arm 40 so as to be rotatable with respect to the second arm 40.

A coupling shaft 44 is secured to the first end 41 of the second arm 40 so as to be inserted in the first arm 30. Moreover, a driven pulley 431 is attached to the first end 41 of the second arm 40 so as to be rotatable with respect to the coupling shaft 44. The driving pulley 432 and the driven pulley 431 are provided to satisfy a diameter ratio of 1:1. A timing belt 433 is wound between the driving pulley 432 and the driven pulley 431.

Moreover, the second end 32 of the first arm 30 is secured to an upper end of the driven pulley 431. A driving pulley 332 is secured to an upper end of the coupling shaft 44 inserted in the first arm 30 to relatively rotate with respect to the first arm 30. A coupling shaft 34 is secured to the first end 31 of the first arm 30. A driven pulley 331 is attached rotatably to the coupling shaft 34. The driving pulley 332 and the driven pulley 331 are provided to satisfy a diameter ratio of 1:2. A timing belt 333 is wound between the driving pulley 332 and the driven pulley 331.

Moreover, the end effecter 20 is secured to an upper end of the driven pulley 331 to relatively turn with respect to the first arm 30.

In the structure described above, when the second rotational input shaft 56 relatively rotates with respect to the first rotational input shaft 55 to cause the second arm 40 to turn, the driving pulley 432 relatively rotates with respect to the first arm 30. A relative torque from the driving pulley 432 is transmitted to the driven pulley 431 through the timing belt 433. Thus, the driven pulley 431 rotates to cause the first arm 30 to turn. When the first arm 30 turns, a relative torque is generated between the first arm 30 and the driving pulley 332. This relative toque is transmitted to the driven pulley 331 through the timing belt 333. Thus, the driven pulley 331 rotates to cause the end effecter 20 to turn.

Herein, the driving pulley 432 and the driven pulley 431 are provided in the second arm 40 so as to satisfy the diameter ratio of 1:1. Moreover, the driving pulley 332 and the driven pulley 331 are provided in the first arm 30 so as to satisfy the diameter ratio of 1:2. Therefore, when the second rotational input shaft 56 rotates, i.e., the second arm 40 turns in an opposite direction to the first rotational input shaft 55 at an identical rotational speed with the first rotational input shaft 55, the driving pulley 432 relatively rotates with respect to the second arm 40 by a rotation amount which is twice as large as that of the second arm 40. As a result, the first arm 30 turns in an opposite direction to the second arm 40 by a rotation amount which is twice as large as that of the second arm 40. Further, the end effecter 20 turns in an opposite direction to the first arm 30 by a rotation amount which is 0.5 times as small as that of the first arm 30.

More specifically, an interlocking mechanism 33 configured with the driving pulley 332, the driven pulley 331 and the timing belt 333 causes the end effecter 20 to turn about the first rotational axis N1 with an angular velocity V1, which is one-half as small as an angular velocity V2 of the first arm 30 that turns about the second rotational axis N2 in a circumferential direction with respect to the second arm 40, in a reverse circumferential direction with respect to the first arm 30. Therefore, the end effecter 20 moves linearly along the straight line connecting between the first rotational axis N1 and the third rotational axis N3. That is, in the case where the horizontal multi-joint robot is configured such that the distance from the first rotational axis N1 to the second rotational axis N2 is equal to the distance from the second rotational axis N2 to the third rotational axis N3, the interlocking mechanism 33 configured with the driving pulley 332, the driven pulley 331 and the timing belt 333 causes the end effecter 20 to turn about the first rotational axis N1 with an angular velocity, which is one-half as small as an angular velocity of the first arm 30 that turns about the second rotational axis N2 in a first direction, in a second direction which is opposite to the first direction.

On the other hand, when the second rotational input shaft 56 rotates, i.e., the second arm 40 turns at an identical rotational speed in an identical direction with respect to the first rotational input shaft 55, the driving pulley 432 does not relatively rotate with respect to the second arm 40. Therefore, the first arm 30 does not turn with respect to the second arm 40, and the end effecter 20 does not turn with respect to the first arm 30. That is, the interlocking operation is effected as described above to maintain such a state that the second arm 40 turns about the third rotational axis N3 with an angular velocity V3 in the circumferential direction and the first arm 30 does not turn about the second rotational axis N2 with respect to the second arm 40. As a result, the entire arm section turns with an arm posture set by the end effecter 20, the first arm 30 and the second arm 40 being maintained. Thus, it is possible to change an orientation of the end effecter 20 that moves linearly.

The following description is given about the third arm 50 that performs swinging and turning motion by the third driving mechanism M3. When the third driving mechanism M3 causes the third arm 50 to turn about the fourth rotational axis N4 with respect to the base 60, the third rotational axis N3 located on the first end 51 of the third arm 50 swings about the fourth rotational axis N4 in an arc shape. On the arc-shaped path, thus, the end effecter 20 moves linearly along the straight line connecting between the first rotational axis N1 and the third rotational axis N3. In this embodiment, the third arm 50 performs the swinging and turning motion in the arc shape, but does not necessarily swing within a given range as described above. For example, the third arm 50 may turn by 360°. As illustrated in FIG. 1, in a case where a workpiece W is transported to and from an access position (a transportation position) P1, the third arm 50 performs the swinging and turning motion until the third rotational axis N3 is aligned with an extension of an imaginary line connecting between “the access position (the transportation position) P1” and “a position P1′ at which the workpiece W must be transported linearly from the access position (the transportation position) P1”. Herein, the position P1′ corresponds to a minimum position, from the access position P1, at which the workpiece W must be transported linearly in a case where a workpiece is transported from a cassette for housing the workpiece only in one direction on the access position P1, or in a case where an obstacle exists around the access position P1. FIG. 1 also illustrates a case where the horizontal multi-joint robot accesses an access position P5.

In the following description, the imaginary line connecting between the access position (the transportation position) P1 and the position P1′ is referred to as an axial line P1a along which the workpiece W is transported to and from the access position P1.

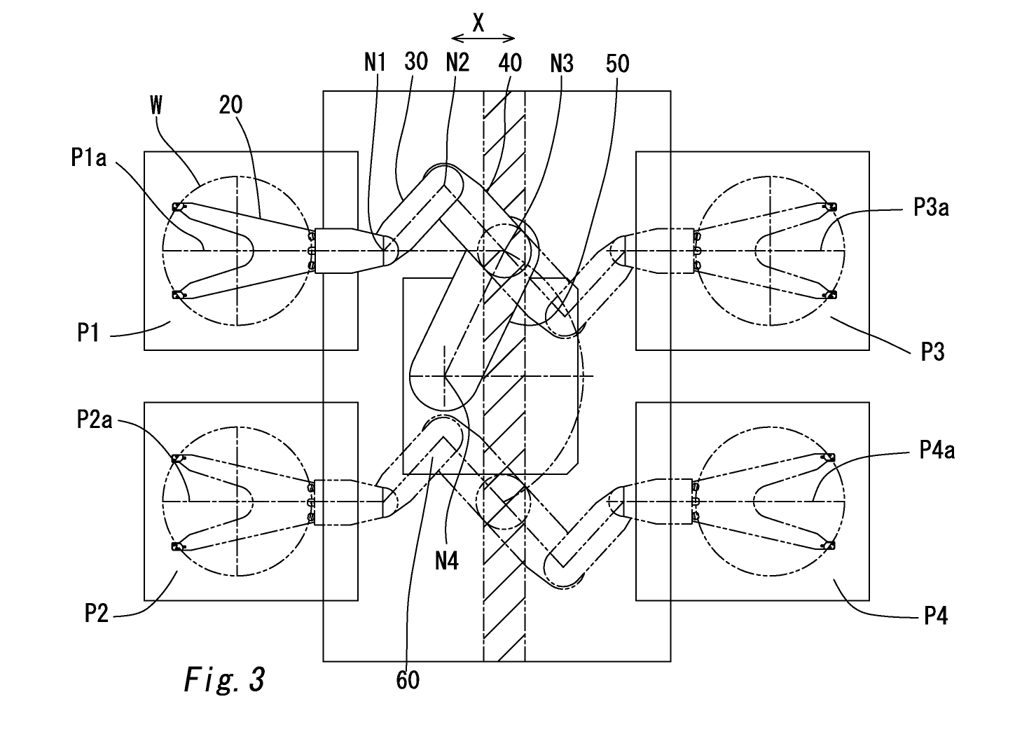

FIG. 3 is a plan view illustrating a transportation apparatus provided with the horizontal multi-joint robot according to this embodiment. In the transportation apparatus, a plurality of access positions (transportation positions) P1, P2, P3 and P4 of cassettes, process devices and the like are arranged and a plurality of axial lines P1a, P2a, P3a and P4a along which a workpiece W is transported are defined in parallel. The process device corresponds to a region where etching, CVD, exposure, washing and the like are carried out in an area for manufacturing a semiconductor, a liquid crystal, a solar cell or the like. As illustrated in FIG. 3, the access positions P1 and P2 are arranged side by side with a given clearance. Moreover, the access positions P3 and P4 are arranged side by side so as to be opposed to the access positions P1 and P2 such that the horizontal multi-joint robot is located between the access positions P1 and P2 and the access positions P3 and P4. In the example illustrated in FIG. 3, the axial line P1a is aligned with the axial line P3a, and the axial line P2a is aligned with the axial line P4a. However, the present invention is not limited to this example as long as the access position is located within such a range that the third rotational axis N3 can reach an extension of each axial line on a required one of the access positions (the transportation positions) as will be described later. Moreover, the side where the access positions P1 and P2 are arranged is separated from the side where the access positions P3 and P4 are arranged, to such a degree that at least the end effecter 20, the first arm 30 and the second arm 40 can turn in a minimum pivoting posture (to be described below). It is needless to say that the side where the access positions P1 and P2 are arranged is separated from the side where the access positions P3 and P4 are arranged, to such a degree that the third arm 50 can perform the swinging and turning motion without hindrance. As will be described later, further, the side where the access positions P1 and P2 are arranged is separated from the side where the access positions P3 and P4 are arranged, to such a degree that the end effecter 20, the first arm 30 and the second arm 40 interferes with no peripheral device while keeping the minimum pivoting posture when the third arm 50 performs the swinging and turning motion.

In the example illustrated in FIG. 3, there is a possibility that the third arm 50 of the horizontal multi-joint robot interferes with the access positions P1 and P2. In order to eliminate this possibility, the third arm 50 is controlled so as to perform the swinging and turning motion about the fourth rotational axis N4 by an angle of not more than 180°. In addition, the fourth rotational axis N4 is spaced equidistantly between the axial line P1a and the axial line P2a. In other words, the fourth rotational axis N4 is located on a line which is spaced equidistantly between the access position P1 and the access position P2. Preferably, when the third arm 50 is controlled so as to perform the swinging and turning motion about the fourth rotational axis N4 by an angle of not more than 180°, the fourth rotational axis N4 is located so as to be close to (so as to be shifted to) one of the side where the access position P1 or P2 is arranged and the side where the access position P3 or P4 is arranged, in a width direction X of the transportation apparatus. Herein, the width direction X is defined by the access position P1 or P2 and the access position P3 or P4. The fourth rotational axis N4 may be made close to (may be shifted to) one of the side where the access position P1 or P2 is arranged and the side where the access position P3 or P4 is arranged, as long as the third arm 50 interferes with no peripheral device in the width direction X even when performing the swinging and turning motion or the end effecter 20, the first arm 30 and the second arm 40 interfere with no peripheral device while keeping the minimum pivoting posture when the third arm 50 performs the swinging and turning motion. In the example illustrated in FIG. 3, the fourth rotational axis N4 is shifted to the side where the access position P1 or P2 is arranged. It is possible to shorten the width direction X of the transportation apparatus in such a manner that the horizontal multi-joint robot is installed as described above. Thus, there is no possibility that the third arm 50 interferes with the access positions P1 to P4.

Accordingly, in a case where the horizontal multi-joint robot accesses the access position P1, first, the third arm 50 performs the swinging and turning motion such that the third rotational axis N3 is aligned with the axial line P1a on the access position (the transportation position) P1. Then, the end effecter 20 turns such that the straight line connecting between the first rotational axis N1 and the third rotational axis N3 is aligned with the axial line P1a, and moves linearly along the axial line P1a. Thus, the horizontal multi-joint robot transports a workpiece to and from the access position P1.

In this embodiment, further, when the third arm 50 performs the swinging and turning motion, the end effecter 20, the first arm 30 and the second arm 40 are brought into the minimum pivoting posture. In addition, the end effecter 20, the first arm 30 and the second arm 40 in the minimum pivoting posture turn on the third rotational axis N3 such that the second rotational axis N2 is always close to the fourth rotational axis N4 with respect to the third rotational axis N3. The following description is given about these matters.

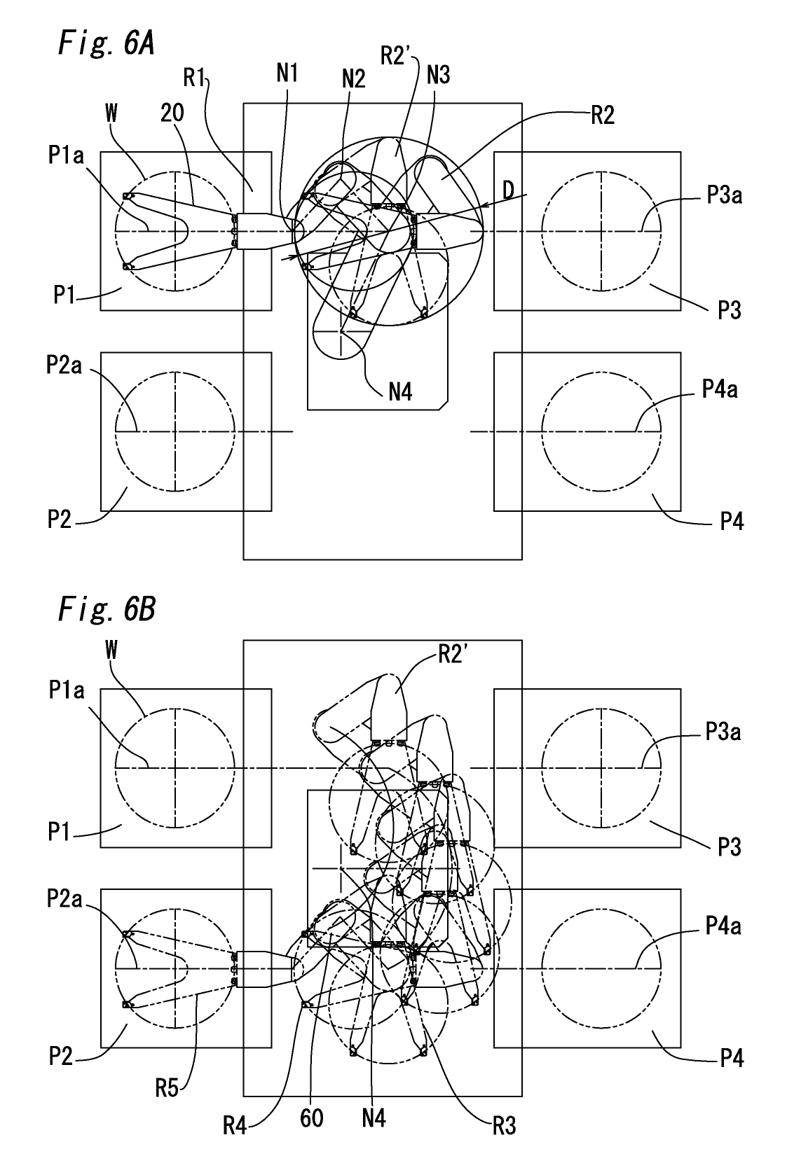

FIGS. 6A and 6B are plan views each illustrating the transportation apparatus in which the third arm 50 of the horizontal multi-joint robot performs the swinging and turning motion. Specifically, FIGS. 6A and 6B illustrate change in arm status (R1, R2, R3, R4, R5) in a case where the horizontal multi-joint robot accesses the access position P1 and then accesses the access position P2. More specifically, FIG. 6A illustrates the change in status (R1, R2), and FIG. 6B illustrates the change in status (R3, R4, R5).

In the status R1, first, the horizontal multi-joint robot accesses the access position P1. In the status R2, thereafter, the end effecter 20, the first arm 30 and the second arm 40 are brought into the minimum pivoting posture. The minimum pivoting posture refers to a posture which ensures a pivot diameter D serving as a minimum requirement in a case where the end effecter 20, the first arm 30 and the second arm 40 turn about the third rotational axis N3. In a case where the end effecter 20 holds a workpiece W, the workpiece W occasionally exerts an influence onto the pivot diameter. Thereafter, the end effecter 20, the first arm 30 and the second arm 40 turn about the third rotational axis N3 while keeping the minimum pivoting posture such that the second rotational axis N2 is close to the fourth rotational axis N4 with respect to the third rotational axis N3 (a status R2′). Then, the third arm 50 starts to perform the swinging and turning motion. During the swinging and turning motion, the end effecter 20, the first arm 30 and the second arm 40 are kept at the minimum pivoting posture on the third rotational axis N3, and are swung while being turned slightly about the third rotational axis N3 such that the second rotational axis N2 is always close to the fourth rotational axis N4 with respect to the third rotational axis N3 (the status R3). When the third rotational axis N3 is aligned with the axial line P2a on the access position P2, the third arm 50 stops to perform the swinging and turning motion. Further, the end effecter 20, the first arm 30 and the second arm 40 turn about the third rotational axis N3 while keeping the minimum pivoting posture such that the straight line connecting between the first rotational axis N1 and the third rotational axis N3 is aligned with the axial line P2a (i.e., such that the end effecter 20 is changed in orientation) (the status R4). Thus, the horizontal multi-joint robot accesses the access position P2 (the status R5).

When the horizontal multi-joint robot operates as described above, the portion on the second rotational axis N2, which corresponds to a so-called elbow of the arm section, does not operate while protruding from the access position P3 or P4. That is, since an operable range required for the robot is not extended more than necessary, the dimension of the transportation apparatus can be reduced at least in the width direction X.

The following description is given about a different case regarding the operations for causing the third arm 50 to perform the swinging and turning motion. As described above, when the third arm 50 performs the swinging and turning motion, the end effecter 20, the first arm 30 and the second arm 40 are brought into the minimum pivoting posture. Further, the end effecter 20, the first arm 30 and the second arm 40 turn on the third rotational axis N3 while keeping the minimum pivoting posture such that the second rotational axis N2 is always close to the fourth rotational axis N4 with respect to the third rotational axis N3. However, these operations may be changed to the following operations.

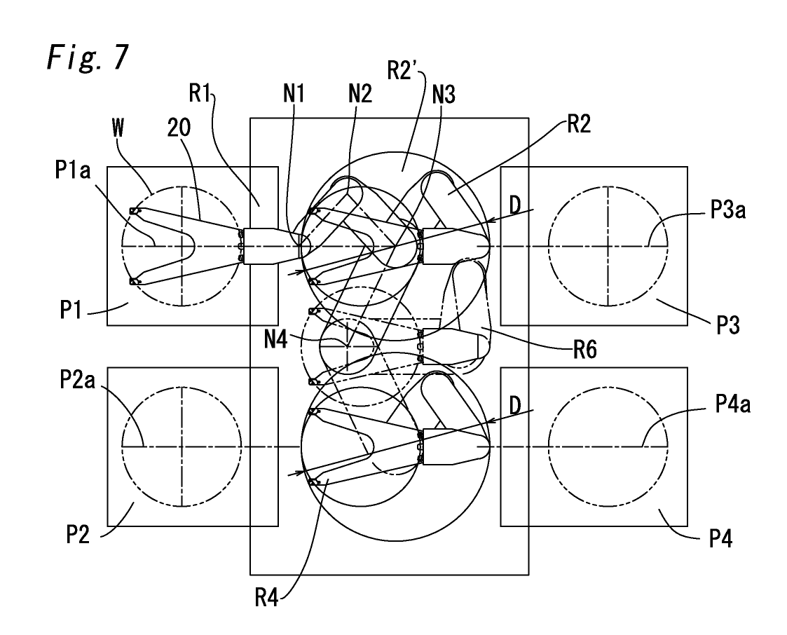

FIG. 7 is a plan view illustrating operations of the transportation apparatus in the case where the third arm 50 of the horizontal multi-joint robot performs the swinging and turning motion, and these operations are different from those illustrated in FIGS. 6A and 6B. FIG. 7 illustrates statuses of the arm section in the case where the robot accesses the access position P1 and then accesses the access position P2, which is similar to FIGS. 6A and 6B.

First, the horizontal multi-joint robot accesses the access position P1 in the status R1 in a manner similar to that illustrated in FIG. 6A. Thereafter, the end effecter 20, the first arm 30 and the second arm 40 are brought into the minimum pivoting posture in the status R2 in a manner similar to that illustrated in FIG. 6A. Unlike the manner illustrated in FIG. 6A, however, the third arm 50 starts to perform the swinging and turning motion and, simultaneously, the end effecter 20, the first arm 30 and the second arm 40 start to operate such that the end effecter 20 moves forward and rearward. In other words, the first arm 30 and the second arm 40 operate as if the end effecter 20 slides apparently. In FIG. 7, a status R6 indicates a midway point of this operation. In the status R6, the end effecter 20, the first arm 30 and the second arm 40 are not in the minimum pivoting posture prior to the start of the swinging and turning motion by the third arm 50, but operate such that the end effecter 20 moves away from the third rotational axis N3. Subsequent to the status R6, when the third arm 50 further performs the swinging and turning motion, the first arm 30 and the second arm 40 operate such that the end effecter 20 moves rearward (a status R4). The status R4 is equal to the status R4 illustrated in FIG. 6B. Then, the horizontal multi-joint robot accesses the access position P2 (the status R5 illustrated in FIG. 6B).

When the horizontal multi-joint robot operates as described above, the dimension of the transportation apparatus can be further reduced in the width direction X as compared with the case where the horizontal multi-joint robot operates as illustrated in FIGS. 6A and 6B. However, the end effecter 20, the first arm 30 and the second arm 40 must be operated in synchronization with the swinging and turning motion by the third arm 50. Therefore, calculations of a program for operating the robot become complicated.

In this embodiment, further, only in the case where the third rotational axis N3 falls within a given range in the width direction X of the transportation apparatus, the end effecter 20, the first arm 30 and the second arm 40 are permitted to turn about the third rotational axis N3 in the minimum pivoting posture. In FIG. 3, a hatched portion indicates the given range. This given range is determined in consideration of a position where the end effecter 20, the first arm 30 and the second arm 40 interfere with no peripheral device even when turning about the third rotational axis N3 in the minimum pivoting posture. The robot operates as described above to avoid interference with a peripheral device. In actual, it is recommended that the robot is controlled in such a manner that an angle of the third arm 50 on the fourth rotational axis N4 is monitored with a controller (not illustrated).

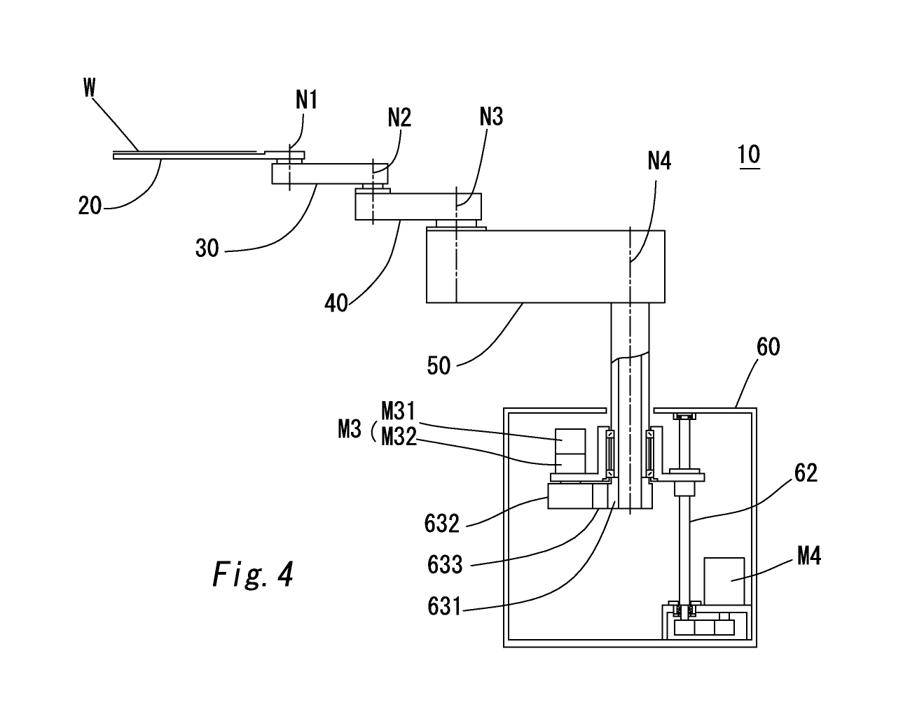

In the horizontal multi-joint robot 10 according to this embodiment, further, as illustrated in FIG. 4, the end effecter 20, the first arm 30, the second arm 40, the third arm 50 and the third driving mechanism M3 are configured to be integrally movable upward and rearward with a lifting mechanism 61 configured with a ball screw 62, the fourth driving mechanism M4 and the like. With this configuration, it is possible to increase a degree of freedom concerning the motion of the horizontal multi-joint robot 10 and to freely transport a workpiece W.

### Second Embodiment

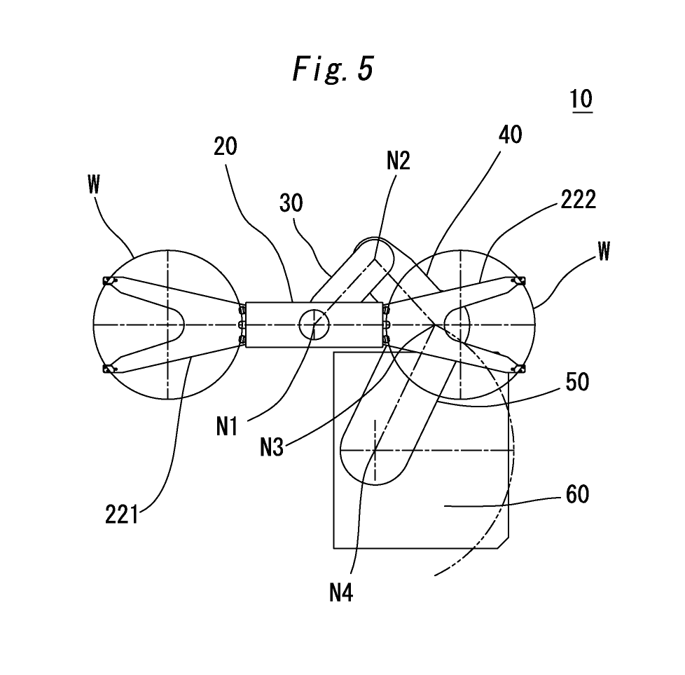

FIG. 5 is a plan view illustrating a horizontal multi-joint robot 10 according to a second embodiment of the present invention. The horizontal multi-joint robot 10 according to this embodiment is equal to that according to the first embodiment except a configuration of an end effecter 20. As illustrated in FIG. 5, the end effecter 20 includes a first hand 221 and a second hand 222 for holding a workpiece W. The first hand 221 and the second hand 222 are arranged symmetrically with respect to a first rotational axis N1.

With this configuration, it is possible to produce the following advantages. That is, two workpieces W can be mounted concurrently on the horizontal multi-joint robot 10. Moreover, a workpiece W can be exchanged with a different one in a cassette or the like in a short time, so that transportation efficiency can be improved.

The horizontal multi-joint robot and the transportation apparatus according to the foregoing embodiments are allowed to produce the following advantages. That is, there is not required a direct-acting mechanism that causes the entire horizontal multi-joint robot to move in parallel with the access position (the transportation position) spaced away from the center of the robot. Moreover, the third arm performs the swinging and turning motion, so that the end effecter moves linearly along the axial line on the access position to transport a workpiece to and from the access position. Accordingly, there is not required a wide space for installation of the robot and the transportation apparatus. In addition, the robot can be installed with ease, and therefore can be overhauled or replaced with a new one in a short time. Further, the robot generates a less amount of dust, so that a clean environment can be maintained.

Moreover, when the third arm performs the swinging and turning motion, the end effecter, the first arm and the second arm are brought into the minimum pivoting posture. In order to realize the swinging and turning motion by the third arm, the end effecter, the first arm and the second arm turn about the third rotational axis such that the second rotational axis is always close to the fourth rotational axis with respect to the third rotational axis. Further, the third arm turns on the third rotational axis while performing the swinging and turning motion such that the second rotational axis is always close to the fourth rotational axis with respect to the third rotational axis. Therefore, an interference area due to the second rotational axis, i.e., the elbow of the arm section is eliminated substantially. As a result, a space required for the robot is further reduced, so that the transportation apparatus including the robot can be reduced in size.

When the third arm performs the swinging and turning motion, the end effecter, the first arm and the second arm are brought into the minimum pivoting posture. Thereafter, the first arm and the second arm move such that the end effecter slides while the third arm performs the swinging and turning motion. Therefore, a space to be required for the robot is further reduced.

Moreover, the first driving mechanism, the second driving mechanism and the third driving mechanism each including the heavy motor and the heavy decelerator are placed in the third arm or the base. As a result, the arm section can be reduced in weight at the distal end thereof. Thus, the entire arm section can be realized in low inertia. Hence, the horizontal multi-joint robot can operate at higher speed, and therefore can contribute to improvement in productivity upon semiconductor manufacture.

Moreover, the lifting mechanism is provided for causing the third arm and the third driving mechanism in addition to the end effecter, the first arm and the second arm to integrally move upward and downward. Accordingly, the horizontal multi-joint robot is increased in degree of freedom concerning motion, and therefore can transport a workpiece more freely.

Moreover, two members, i.e., the first hand and the second hand are provided for holding a workpiece. As a result, two workpieces can be mounted concurrently on the horizontal multi-joint robot. Therefore, a workpiece can be exchanged with a different one in a cassette in a short time, so that transportation efficiency can be improved.

It is assumed herein that the foregoing horizontal multi-joint robot is installed in the transportation apparatus in which, of the plurality of transportation positions, the first transportation position and the second transportation position are arranged at least side by side, and at least the third transportation position is further arranged at an opposite side to the side where the first and second transportation positions are arranged side by side with the horizontal multi-joint robot located between the two sides. In such a case, the fourth rotational axis is shifted to one of the side where the first or second transportation position is arranged and the side where the third transportation position is arranged in the width direction X of the transportation apparatus defined by the first or second transportation position and the third transportation position. Therefore, the entire transportation apparatus can be reduced in size.

Moreover, the end effecter, the first arm and the second arm are permitted to turn about the third rotational axis in the minimum pivoting posture only in a case where the third rotational axis falls within a given range in the width direction X. Therefore, it is possible to reduce a possibility that the arm section interferes with a device provided around the robot, and to transport a workpiece with safe.

The foregoing embodiments concern a horizontal multi-joint robot for transporting a workpiece such as a semiconductor wafer between a cassette and a process device. In addition, the present invention is applicable to transportation of a large-size workpiece such as a liquid crystal panel in such a manner that the end effecter and the arm section are increased in size or are enhanced in rigidity.

Obviously, numerous modifications and variations of the present invention are possible in light of the above teachings. It is therefore to be understood that within the scope of the appended claims, the invention maybe practiced otherwise than as specifically described herein.

What is claimed as new and is desired to be secured by Letters Patent of the United States is:

1. A horizontal multi-joint robot for transporting a workpiece to a desired transportation position, comprising:
an end effecter for holding a workpiece;
a horizontal multi-joint type arm section including
a first arm having a first rotational axis at a first end thereof, and supporting the end effecter such that the end effecter turns about the first rotational axis,
a second arm having a second rotational axis at a first end thereof, and supporting a second end of the first arm such that the first arm turns about the second rotational axis, and
a third arm having a third rotational axis at a first end thereof, and supporting a second end of the second arm such that the second arm turns about the third rotational axis;
a base having a fourth rotational axis, and supporting a second end of the third arm such that the third arm turns about the fourth rotational axis; and
an interlocking mechanism causing the end effecter to turn about the first rotational axis with an angular velocity, which is one-half as small as an angular velocity of the first arm that turns about the second rotational axis in a first direction, in a second direction which is opposite to the first direction in a case where a distance from the first rotational axis to the second rotational axis is equal to a distance from the second rotational axis to the third rotational axis, wherein
the workpiece is transported in such a manner that the third arm performs swinging and turning motion until the third rotational axis is aligned with an imaginary extension of an axial line on the transportation position.

2. The horizontal multi-joint robot according to claim 1, wherein
when the third arm performs the swinging and turning motion, the end effecter, the first arm and the second arm are brought into a minimum pivoting posture, and turn on the third rotational axis while keeping the minimum pivoting posture such that the second rotational axis is always close to the fourth rotational axis with respect to the third rotational axis.

3. The horizontal multi-joint robot according to claim 1, wherein
when the third arm performs the swinging and turning motion, the end effecter, the first arm and the second arm are brought into a minimum pivoting posture, and then the first and second arms move such that the end effecter slides, while the third arm performs the swinging and turning motion.

4. The horizontal multi-joint robot according to claim 1, wherein
a first driving mechanism causing the first arm to turn about the second rotational axis and a second driving mechanism causing the second arm to turn about the third rotational axis are placed in the third arm, and
a third driving mechanism causing the third arm to turn about the fourth rotational axis is placed in the base.

5. The horizontal multi-joint robot according to claim 4, further comprising
a lifting mechanism placed in the base to cause the end effecter, the first arm, the second arm, the third arm and the third driving mechanism to move upward and downward.

6. The horizontal multi-joint robot according to claim 1, wherein
the end effecter includes a first hand and a second hand arranged symmetrically with respect to the first rotational axis, and
the first hand and the second hand hold the workpieces, respectively.

7. A transportation apparatus comprising:
a plurality of transportation positions to which a workpiece is transported; and
a horizontal multi-joint robot which transports the workpiece to the transportation position, wherein
of the plurality of transportation positions, the first transportation position and the second transportation position are arranged at least side by side,
the horizontal multi-joint robot includes:
an end effecter for holding the workpiece;
a horizontal multi-joint type arm section including
a first arm having a first rotational axis at a first end thereof, and supporting the end effecter such that the end effecter turns about the first rotational axis,
a second arm having a second rotational axis at a first end thereof, and supporting a second end of the first arm such that the first arm turns about the second rotational axis, and
a third arm having a third rotational axis at a first end thereof, and supporting a second end of the second arm such that the second arm turns about the third rotational axis;
a base having a fourth rotational axis, and supporting a second end of the third arm such that the third arm turns about the fourth rotational axis; and
an interlocking mechanism causing the end effecter to turn about the first rotational axis with an angular velocity, which is one-half as small as an angular velocity of the first arm that turns about the second rotational axis in a first direction, in a second direction which is opposite to the first direction in a case where a distance from the first rotational axis to the second rotational axis is equal to a distance from the second rotational axis to the third rotational axis,
the fourth rotational axis is located on a line spaced equidistantly between the first transportation position and the second transportation position, and
the workpiece is transported in such a manner that the third arm performs swinging and turning motion until the third rotational axis is aligned with an imaginary extension of an axial line on one of the first transportation position and the second transportation position.

8. The transportation apparatus according to claim 7, wherein
when the third arm performs the swinging and turning motion, the end effecter, the first arm and the second arm are brought into a minimum pivoting posture, and turn on the third rotational axis while keeping the minimum pivoting posture such that the second rotational axis is always close to the fourth rotational axis with respect to the third rotational axis.

9. The transportation apparatus according to claim 7, wherein
when the third arm performs the swinging and turning motion, the end effecter, the first arm and the second arm are brought into a minimum pivoting posture, and then the first and second arms move such that the end effecter slides, while the third arm performs the swinging and turning motion.

10. The transportation apparatus according to claim 7, further comprising
at least a third transportation position arranged on a side opposite to a side where the first transportation position and the second transportation position are arranged, with the horizontal multi-joint robot located between the two sides, wherein
in a width direction of the transportation apparatus defined by one of the first and second transportation positions and the third transportation position,
the fourth rotational axis is shifted to one of the side where one of the first and second transportation positions is arranged and the side where the third transportation position is arranged.

11. The transportation apparatus according to claim 7, wherein
the end effecter, the first arm and the second arm turn about the third rotational axis in the minimum pivoting posture only in a case where the third rotational axis falls within a given range in the width direction.

12. The transportation apparatus according to claim 7, wherein
the horizontal multi-joint robot further includes a lifting mechanism placed in the base to cause the end effecter, the first arm, the second arm, the third arm and the third driving mechanism to move upward and downward.

13. The transportation apparatus according to claim 7, wherein
the end effecter of the horizontal multi-joint robot includes a first hand and a second hand arranged symmetrically with respect to the first rotational axis, and
the first hand and the second hand hold the workpieces, respectively.
